(19) United States
(12) Patent Application Publication
(10) Pub. No.: US 2022/0354308 A1
(43) Pub. Date: Nov. 10, 2022

(54) FOOD PROCESSOR WITH BLENDING AND STEAMING FUNCTIONALITY

(71) Applicants: Jose Longoria, Miami, FL (US); Melvin R. Kennedy, Santa Barbara, CA (US); Robert G. Robbins, Boca Raton, FL (US); Lee Ann Taylor, Chatham, NJ (US)

(72) Inventors: Jose Longoria, Miami, FL (US); Melvin R. Kennedy, Santa Barbara, CA (US); Robert G. Robbins, Boca Raton, FL (US); Lee Ann Taylor, Chatham, NJ (US)

(21) Appl. No.: 17/738,096

(22) Filed: May 6, 2022

Related U.S. Application Data
(60) Provisional application No. 63/185,255, filed on May 6, 2021.

(51) Int. Cl. A47J 43/07; A47J 27/04; A47J 43/046

(52) U.S. Cl. CPC A47J 43/0727; A47J 27/04; A47J 43/046; A47J 43/0722; A47J 43/0772; A47J 2027/043

(57) ABSTRACT

The present food processing device is configured to hold food within a receptacle during cooking and subsequently during blending. It is desirable that the food processing device provides control for the flow of the steam during steam cooking of the food processing device, and then makes it easy to remove the food out after the food processing device has been blended.

### CROSS-REFERENCE TO RELATED APPLICATIONS

This application claims priority to U.S. Application Ser. No. 63/185,255 filed on May 6, 2021, the entire contents of which are herein fully incorporated by reference in its entirety.

### FIELD OF THE EMBODIMENT

The field of the embodiment of the present application relates to a food processing device for holding the food in the proper position during cooking and during blending. In particular, the present application describes a device that provides control for the flow of the steam during cooking and makes it easier to scoop the food out after it has been processed.

### BACKGROUND OF THE EMBODIMENTS

There are many food processors and blenders available in the marketplace designed for various purposes from mixing frozen fruit smoothies to cooking food and blending baby food. These appliances have many features, and some even have the ability to cook food and then shift to blending the food once it has been cooked. This is particularly desirable for those intending to make their own baby food.

As noted, there are food processors which have a drive mechanism for an agitator or blade in a mixing vessel. Food processors of this kind serve, for example, for the production of various foodstuffs. Depending on the construction of the agitator or blade, the introduced ingredients are chopped, diced, kneaded, or the like, or some combination thereof.

It is further known, for example, to equip food processors with a heater. Food processors constructed in this manner can be used, for example, for the production of soups, sauces, or the like. Other such heating devices are utilized to steam or cook the food processing device to a person's liking.

It is preferred to have a food processing device that can not only cook and/or steam food processing device but also process (chop, dice, etc.) the food processing device whether it was first steamed or not. The present application and its embodiments meet and exceed these objectives.

Review of related technology:

U.S. Pat. No. 6,703,061 pertains to a food processing device preparation system and method, including a base housing, a container detachably engageable with the base housing in which the container is adapted to receive food processing device products. The system also includes a heater within the base housing and/or the container for converting a liquid into a cooking vapor, and a blade rotatably mounted in the container in which the blade supports the food processing device products during a cooking step and processes the food processing device products during a processing step. The system can also have positioning structure within the base housing and/or the container for positioning the blade in a cooking position during the cooking step, and for positioning the blade in a processing position during the processing step.

U.S. Pat. No. 5,794,524 pertains to a food processing device processor with a mixing vessel and a drive mechanism for an agitator in the mixing vessel, the lower region of which can be heated. As a simple way of improving a food processing device processor of this type, it is proposed that a top unit for the mixing vessel should have a perforated base to allow food processing device to be steam cooked. The perforations are formed in a support plate in the base of the top unit and condensation and moisture are led back into the mixing vessel.

U.S. Patent Application Publication 2019/0231147 pertains to a food processing device preparation device that includes a receptacle, a manipulator, one or more sensors and a processor. The processor can recognize one or more food processing device items being prepared on the receptacle to detect attributes of each food processing device item of the one or more food processing device items, based on the sensor data of the one or more sensors. Additionally, the processor can control a cooking operation of the manipulator based on the detected attributes.

European Patent 2832273 pertains to a steam cooking container that can be coupled on top of a container, the cooking container having holes for the passage of steam and an upper access opening. Said container comprises an opening for the entry of steam and a support for holding foods located above said opening, demarcating a cavity for receiving foods and said support having holes for the passage of steam to said cavity. A section of the steam cooking container is arranged below the opening forming a cavity for condensate retention, demarcated by walls and a bottom. In the cooking position, the holes of the support for holding foods and said opening are not superimposed on, or not coinciding or not aligned with one another.

Thus, various food blending and food steaming devices are known in the art. However, their structure and means of operation are substantially different from the present disclosure. The other food blending/steaming devices fail to solve all the problems taught by the present disclosure. At least one embodiment of this invention is presented in the drawings below and will be described in more detail herein.

### BRIEF SUMMARY OF THE EMBODIMENTS

In general, the present application provides for a food processing device that has both steaming and blending/chopping/dicing/etc. functionality. The food processing device has a reservoir to hold a volume of a fluid such as liquid water. A heating element is used to create a gas from the volume of fluid such as steam from the liquid water. This gas can then follow a steam path created by a series of ports disposed in both the base unit of the food processing device as well as the receptacle and lid that is configured to couple thereto. Ultimately, the steam (or gas) is allowed to escape from the enclosed receptacle by way of the lid. This allows for the food processing device item within the receptacle to be cooked via the steam. Once cooked to a desired consistency, the blades of the food processing device may then be used to modify a consistency of the food processing device. In at least one embodiment, once the steamed food is processed, the food may be acceptable for baby food.

Alternatively, the food processing device may be used to simply blend/dice/chop etc. the food items placed within the receptacle without first steaming the food. An auger or rotating member is used to turn at least one blade within the receptacle thereby modifying a consistency of the food processing device item.

In one aspect of the present application there is a food processing device that includes a base unit having a reservoir configured to retain a fluid, where a heating element is configured to heat the fluid causing the fluid to enter a gaseous state, a receptacle having a lid, a base, and at least one sidewall defining an interior of the receptacle, and a central support element configured to couple to an inner bottom surface of the receptacle and a bottom surface of the lid, where a fluid pathway is defined from the reservoir to the interior of the receptacle.

The food processing device may also include blades disposed on the central support element.

The food processing device may also include where the fluid pathway includes a first port on the base unit in fluid communication with a second port on the lid.

The food processing device may also include a third port on the lid.

The food processing device may also include where the fluid pathway includes an interior of the central support element.

The food processing device may also include a male connector configured to engage a recess of the central support element.

The food processing device may also include at least one fourth port disposed on the central support element.

The food processing device may also include where the central support element is removable from the receptacle.

In another aspect of the present application there is a food processing device that includes a base unit having a reservoir configured to retain a volume of liquid, where a heating element is configured to heat the volume of liquid causing the volume of liquid to form a gas, and where the base unit has a first port. The food processing device also includes a receptacle having a lid, a base, and at least one sidewall defining an interior of the receptacle, where the lid has a second port and a third port. The food processing device also includes a central support element configured to couple to an inner bottom surface of the receptacle and a bottom surface of the lid, where the central support element has at least one fourth port disposed therein. The food processing device also includes where a fluid pathway for the gas is defined by the first port, the second port, the third port, and at least one fourth port.

The food processing device may also include where the fluid pathway begins at the reservoir and ends at a top surface of the lid.

The food processing device may also include a male connector disposed on a bottom surface of the lid, where the male connector is configured to engage a recess of the central support element.

In one aspect, the food processing device further includes a locking mechanism configured to secure a position of the central support element within the receptacle.

In yet another aspect of the present application there is a food processing device that includes a base unit having a first port and a reservoir configured to selectively retain a volume of water, a heating element housed in the base unit, where the heating element is configured to heat the volume of water causing the volume of water to form steam, a receptacle having a base, and at least one sidewall defining an interior of the receptacle, a lid configured to selectively cover an opening of the receptacle where the lid has a second port and a third port, and a central support element supporting at least one blade, where the central support element is configured to couple to an inner bottom surface of the receptacle and a bottom surface of the lid, where the central support element has at least one fourth port disposed therein. The food processing device also includes a connector disposed on the bottom surface of the lid, the connector configured to engage the central support element.

The food processing device also includes where a fluid pathway for the steam is defined by the first port, the second port, the third port, and at least one fourth port being in fluid communication.

The food processing device may also include where the at least one blade has a plurality of apertures coupling a top surface of the at least one blade with a bottom surface of the at least one blade.

The food processing device may also include where the steam is configured to leave the base unit pass through an interior of the lid, pass through an interior of the central support element, and pass through the bottom surface and an upper surface of the lid.

The food processing device may also include where there are four fourth ports.

The food processing device may also include where the third port couples the bottom surface of the lid to a top surface of the lid.

The food processing device may also include where the male connector extends from the bottom surface of the lid.

The food processing device may also include where the second port is coupled to the male connector.

The food processing device may also include where the four ports are located in a stacked configuration on opposing sides of the central support element. Other technical features may be readily apparent to one skilled in the art from the following figures, descriptions, and claims.

### BRIEF DESCRIPTION OF THE DRAWINGS

To easily identify the discussion of any particular element or act, the most significant digit or digits in a reference number refer to the figure number in which that element is first introduced.

FIG. 1 illustrates a perspective view of an embodiment of the present application.

FIG. 2A illustrates a side view of a first embodiment of a receptacle of the present application.

FIG. 2B illustrates a side view of a second embodiment of a receptacle of the present application.

FIG. 3A illustrates a side view of a first blade assembly of a receptacle of the present application.

FIG. 3B illustrates a side view of a second blade assembly of a receptacle of the present application.

FIG. 4 illustrates a sectional side view of a receptacle of the present application showing a steam path consistent with the present application.

FIG. 5 illustrates an underside of the lid of a receptacle of the present application.

FIG. 6 illustrates a side view of a receptacle of the present application showing a drive mechanism for the central support element.

FIG. 7 illustrates a schematic showing a complete steam path from the reservoir to and out the receptacle of the present application.

FIG. 8 illustrates the removal of a steamed and/or blended food processing device item from an embodiment of the present application.

### DETAILED DESCRIPTION OF THE EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

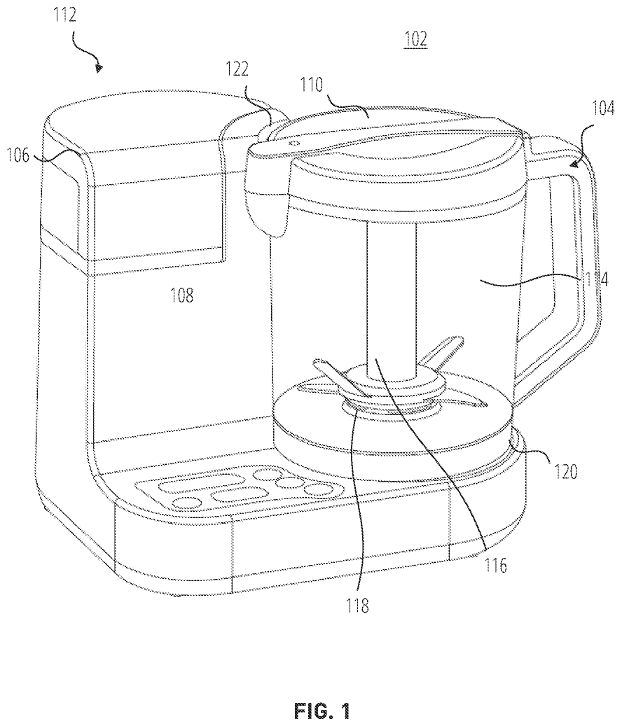

Referring now to FIG. 1, there is an embodiment of the food processing device 102 of the present application. The food processing device 102 may include a receptacle 104, a reservoir 106, a heating element 108, a first port 122, a lid 110, a base unit 112, an at least one sidewall 114, a central support element 116, a base 120, and an at least one blade 118. A power source (not shown) may be a battery, a solar cell, or an AC or DC connector.

The base unit 112 preferably contains the circuitry (wiring, PCB, motor, drive mechanism, processor, etc.) necessary for the general operation of the food processing device 102. The base unit 112 may contain touch sensitive buttons (depressible, touch screen, etc.) to cause the food processing device 102 to start or stop operation, such as rotation of blades and/or steaming, and choose various functionality (steam, blend, etc.) depending on the user's needs.

The base unit 112 also houses the reservoir 106 and the heating element 108. The reservoir 106 may be a removable unit to be coupled to the base unit 112 configured to house a volume of a fluid such as water. The reservoir 106 has at least one opening by which the fluid can be introduced into the reservoir 106. The fluid within the reservoir 106 is heated, via the heating element 108, to a gaseous state. Once in a gaseous state, the fluid can be introduced into the receptacle 104 thereby allowing the food within the receptacle 104 to be “steamed.”

The heating element 108 may be affixed directly to the reservoir 106 thereby causing the fluid within the reservoir 106 to heat up to a gaseous state. In other embodiments, there is a metering device configured to allow an amount of the fluid to leave the reservoir 106 and interact with the heating element 108 thereby causing the fluid to enter the gaseous state outside of the confines of the reservoir 106. Once the fluid has been sufficiently heated and enters the gaseous state, it can then be introduced to the receptacle 104 via a series of ports.

Separate from the base unit 112 is the receptacle 104. The receptacle 104 preferably has a lid 110, a base 120, a central support element 116, at least one sidewall 114, and at least one blade 118. The lid 110 is removable to allow for easy entrance and removal of any food item placed within the interior volume defined by the at least one sidewall 114 and base 120 of the receptacle 104. Locking mechanisms may allow for the lid 110 to be securely positioned during use. In at least one embodiment, the lid 110 is required to be secured into a “locked” position in order for the food processing device 102 to operate.

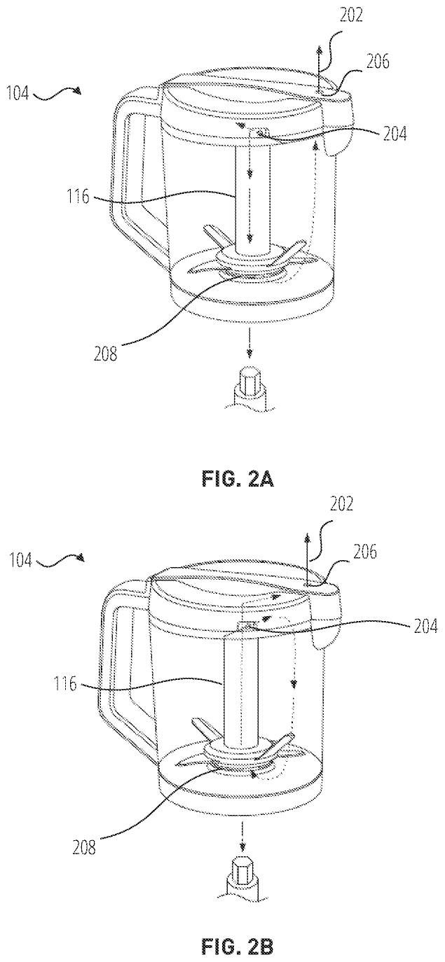

The receptacle 104 itself is also removable from the base unit 112. The receptacle 104 may lock into place upon the base unit 112 and interact with a drive mechanism (see FIGS. 2A-2B) configured to drive the at least one blade 118. The receptacle 104 is configured to be positioned on the base unit 112 such that the ports between the base unit 112 and the receptacle 104 align to form a fluid pathway 202 (as shown in FIGS. 2A-2B).

Referring now to FIGS. 2A-2B, there is an alternative view of the receptacle 104 illustrating potential fluid pathways 202. In each instance, there is a first port 122, as shown in FIG. 1, on the base unit 112 in fluid communication with the reservoir 106 as described in FIG. 1. This first port is configured to align with the second port 204 on the receptacle 104. A third port 206 is located in a lid 110 of the receptacle 104 and at least one fourth port 208 is located as part of the central support element 116.

In a preferred embodiment, as shown in FIG. 2A, the fluid pathway 202 achieves fluid communication between the first port 122 (see FIG. 1), second port 204, third port 206, and at least one fourth port 208. Here, the gaseous state fluid or steam enters the second port 204 on a lid 110 of the receptacle 104. The steam then exits the lid 110 on an underside of the lid 110 and enters an interior of the central support element 116. The central support element 116 has at least one fourth port 208 near a bottom of the central support element 116 that allows the steam to permeate the interior volume of the receptacle 104. The steam can then exit the receptacle 104 via a third port 206 which is also located in the lid 110 of the receptacle 104. The arrows in FIG. 2A show the fluid pathway 202.

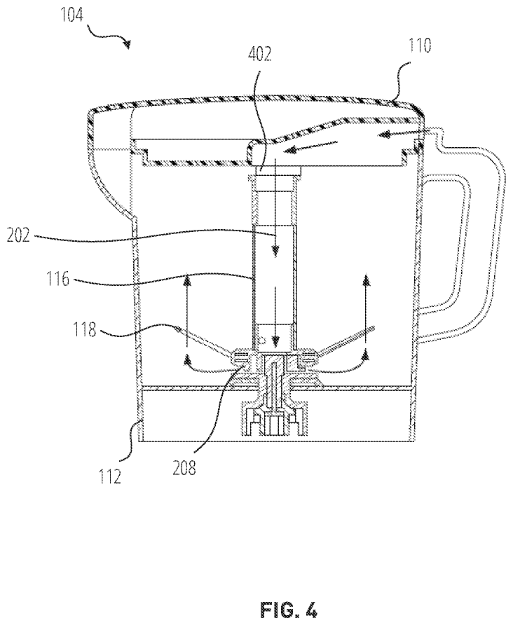

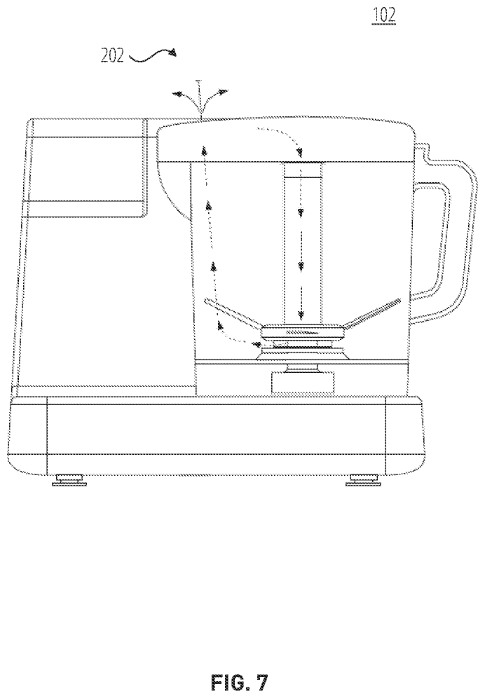

This is further represented as a sectional side view of the fluid pathway 202 as shown in FIG. 4. As described, the gaseous state fluid is depicted as traveling along the fluid pathway 202 denoted by arrows. The interface of the male connector 402 and the central support element 116 is represented and forms the section of the fluid pathway 202 along an interior volume of the receptacle 104. This allows the gaseous state fluid to move from the lid 110 down through the central support element 116 and out through the at least one fourth port 208 into the interior volume of the receptacle 104. In at least one embodiment, the at least one fourth port 208 is located below a level of the at least one blade 118 and preferably as close to a bottom of an interior of the receptacle 104 as possible. This allows for the gaseous state fluid to permeate an entirety of the interior volume of the receptacle 104 as well as be positioned below any food item in the receptacle 104 such that it can be most thoroughly steamed. Such a fluid pathway 202, shown as complete between the two components (receptacle and base unit) of the food processing device 102 is further represented in FIG. 7.

In an alternate embodiment of the fluid pathway 202, as shown in FIG. 2B, the fluid pathway 202 utilizes the same ports as described in FIG. 2A. Here, however, the second port 204 allows for introduction of the gaseous fluid (steam) directly into the interior volume of the receptacle 104 which then leaves through the at least one fourth port 208 and the third port 206. Such allows for a different arrangement of components and the “entrance” from the second port into an interior of the central support element 116 would be shifted such that it is introduced directly into the interior volume of the receptacle. In such an embodiment, additional features such as mechanisms configured to generate suction may help to remove gaseous state fluid from the interior or may allow for the gaseous state fluid to passively leave through one of the ports.

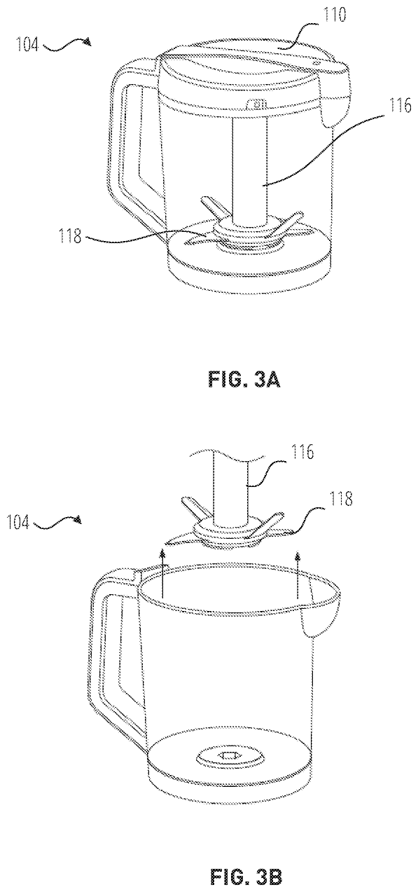

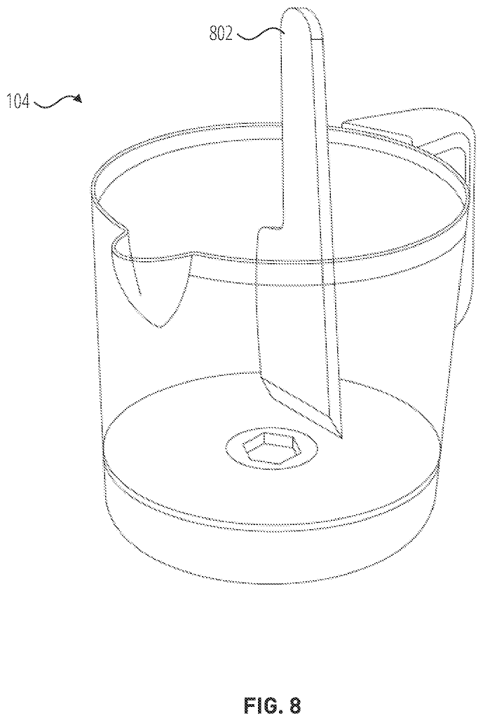

As shown in FIGS. 3A-3B, the food processing device 102 not only steams food placed therein but is also capable of blending, chopping, dicing, and the like or some combination thereof the food. Preferably, once the food has been steamed by the process and mechanisms described in FIGS. 1-2B, the food may then be blended, chopped, or otherwise modified in consistency by the at least one blade 118. The central support element 116 which houses the at least one blade 118 is rotationally driven by a drive mechanism as shown by FIGS. 2A-2B. Once the food has been blended, the lid 110 of the receptacle 104 may be removed thereby allowing the central support element 116 to be removed as well as illustrated between FIGS. 3A-3B. This allows for easy removal of the food items contained therein by a spatula 802 or another utensil as shown in FIG. 8.

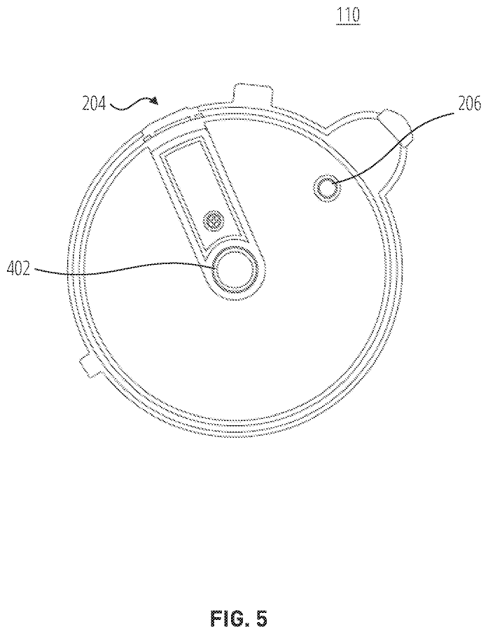

As noted in FIGS. 2A-2B, the second port 204 is in a lid 110 of the receptacle 104 and preferably in a sidewall of the lid 110. An underside of the lid 110 is shown in FIG. 5. Shown here, is the third port 206, the second port 204, and the male connector 402. The third port 206 is configured to couple a bottom surface of the lid 110 with a top surface of the lid 110. The third port 206 thereby allows the gaseous state fluid to escape from the interior volume of the receptacle 104 when the lid 110 is coupled to the receptacle 104.

The second port 204 is coupled to the male connector 402 by a channel on an interior of the lid 110. This allows for the gaseous state fluid to enter the lid 110 at the second port 204 and travel along the channel and exit the underside of the lid 110 at an interior of the male connector 402. In at least one embodiment, the male connector 402 is a ring of material that extends from a bottom surface of the lid 110. As shown in FIG. 4, the male connector 402 is sized and shaped to engage a recess on a top of the central support element 116 and engage or form a seal with a recess of the central support element 116. This may form a continuous channel with a hollow interior of the central support element 116 which prevents escape of the gaseous state fluid from the fluid pathway 202 before it exists at the at least one fourth port 208.

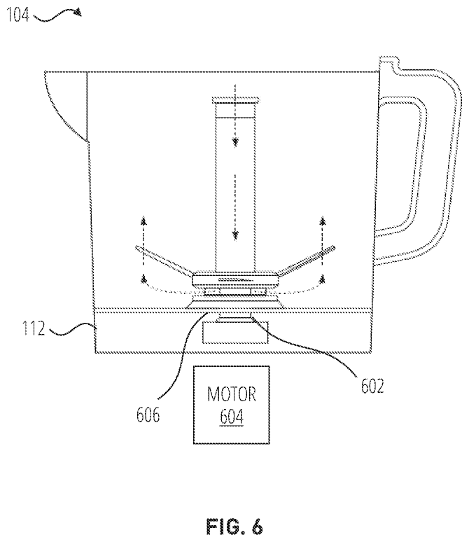

The central support element 116 rests upon an idler device 602 as shown in FIG. 6. The idler device 602 is configured to secure a position of the central support element 116 on a bottom surface of the receptacle 104 and to transfer rotational energy from the motor 604 to the at least one blade 118. The idler device 602 is positioned through an opening in a bottom of the receptacle 104. The idler device is surrounding by a sealing member 606. The sealing member 606 may function as both a seal and a bearing. This enables the receptacle 104 to contain a liquid tight seal at the bottom preventing spillage of any food item from within the receptacle 104 as well as facilitate the rotation of the idler device 602. A protrusion of the idler device 602 engages with a complementary recess on underside of the central support element 116. Equally, a protruding portion of the drive mechanism engages with a complementary recess on the idler device 602. Once assembled and ready for use, the drive mechanism, idler device 602, and central support element 116 allow for the at least one blade 118 to be rotated thereby causing the food item contained in the receptacle to be diced, chopped, etc.

Although this invention and its embodiments have been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A food processing device comprising:
a base unit having a reservoir configured to retain a fluid,
wherein a heating element is configured to heat the fluid causing the fluid to enter a gaseous state;
a receptacle having a lid, a base, and at least one sidewall defining an interior of the receptacle; and
a central support element configured to couple to an inner bottom surface of the receptacle and a bottom surface of the lid,
wherein a fluid pathway is defined from the reservoir to the interior of the receptacle.

2. The food processing device of claim 1 further comprising blades disposed on the central support element.

3. The food processing device of claim 1 wherein the fluid pathway comprises a first port on the base unit in fluid communication with a second port on the lid.

4. The food processing device of claim 1 further comprising a third port on the lid.

5. The food processing device of claim 4 wherein the third port couples the bottom surface of the lid to a top surface of the lid.

6. The food processing device of claim 1 wherein the fluid pathway comprises an interior of the central support element.

7. The food processing device of claim 1 further comprising a male connector configured to engage a recess of the central support element.

8. The food processing device of claim 7 wherein the male connector extends from the bottom surface of the lid.

9. The food processing device of claim 1 further comprising at least one fourth port disposed on the central support element.

10. The food processing device of claim 1 wherein the central support element is removable from the receptacle.

11. A food processing device comprising:
a base unit having a reservoir configured to retain a volume of liquid,
wherein a heating element is configured to heat the volume of liquid causing the volume of liquid to form a gas, and
wherein the base unit has a first port:
a receptacle having a lid, a base, and at least one sidewall defining an interior of the receptacle,
wherein the lid has a second port and a third port; and
a central support element configured to couple to an inner bottom surface of the receptacle and a bottom surface of the lid,
wherein the central support element has at least one fourth port disposed therein;
wherein a fluid pathway for the gas is defined by the first port, the second port, the third port, and at least one fourth port.

12. The food processing device of claim 11 wherein the fluid pathway begins at the reservoir and ends at a top surface of the lid.

13. The food processing device of claim 11 further comprising a male connector disposed on a bottom surface of the lid, wherein the male connector is configured to engage a recess of the central support element.

14. The food processing device of claim 13 wherein the second port is coupled to the male connector.

15. The food processing device of claim 11 further comprising a locking mechanism configured to secure a position of the central support element within the receptacle.

16. A food processing device comprising:
a base unit having a first port and a reservoir configured to selectively retain a volume of water,
a heating element housed in the base unit,
wherein the heating element is configured to heat the volume of water causing the volume of water to form steam;
a receptacle having a base, and at least one sidewall defining an interior of the receptacle;
a lid configured to selectively cover an opening of the receptacle
wherein the lid has a second port and a third port; and
a central support element supporting at least one blade,
wherein the central support element is configured to couple to an inner bottom surface of the receptacle and a bottom surface of the lid,
wherein the central support element has at least one fourth port disposed therein;
a connector disposed on the bottom surface of the lid, the connector configured to engage the central support element;
wherein a fluid pathway for the steam is defined by the first port, the second port, the third port, and at least one fourth port being in fluid communication.

17. The food processing device of claim 16 wherein the at least one blade has a plurality of apertures coupling a top surface of the at least one blade with a bottom surface of the at least one blade.

18. The food processing device of claim 16 wherein the steam is configured to leave the base unit pass through an interior of the lid, pass through an interior of the central support element, and pass through the bottom surface and an upper surface of the lid.

19. The food processing device of claim 16 wherein there are four fourth ports.

20. The food processing device of claim 19 wherein the four ports are located in a stacked configuration on opposing sides of the central support element.
